(19) United States
(12) Patent Application Publication
(10) Pub. No.: US 2012/0235787 A1
(43) Pub. Date: Sep. 20, 2012

(54) METHOD AND NEAR FIELD COMMUNICATION DEVICE AND CORRESPONDING COMPUTER PROGRAMME

(75) Inventors: Vincent Brient, Saint-Ouen-Des-Alleux (FR); Yannick Delibie, Thorigne-Fouillard (FR)

(73) Assignee: KERLINK SA, Rennes Cedex (FR)

(21) Appl. No.: 13/398,383

(22) Filed: Feb. 16, 2012

Related U.S. Application Data
(60) Provisional application No. 61/452,914, filed on Mar. 15, 2011.

(30) Foreign Application Priority Data
Feb. 18, 2011 (FR) 1151368

(51) Int. Cl. H04B 5/00; G05B 19/00

(52) U.S. Cl. 340/5.61

(57) ABSTRACT

A method and apparatus are provided for near field communication, which implement at least one communication reader configured to exchange data with at least one nomadic object. The method includes detecting a presence in the vicinity of the communication reader, delivering activation information, when a presence is detected, activating the power supply of the communication reader, upon reception of the activation information, and authorizing a self-service access according to at least one of said data exchanged.

### CROSS-REFERENCE TO RELATED APPLICATIONS

The present application is based on and claims the benefit of U.S. provisional patent application Ser. No. 61/452,914, filed Mar. 15, 2011, the content of which is hereby incorporated by reference in its entirety.

### STATEMENT REGARDING FEDERALLY SPONSORED RESEARCH OR DEVELOPMENT

None.

### THE NAMES OF PARTIES TO A JOINT RESEARCH AGREEMENT

None.

### FIELD OF THE DISCLOSURE

The field of the disclosure is that of near field communications, implementing near field communication readers and nomadic objects, such as contactless chip cards of the RFID type (for “Radio Frequency IDentification”) or NFC labels (for “Near Field Communication”), in order to exchange data.

In particular, the disclosure has applications in sharing systems, or self-service access, for vehicles (car, bicycle, bus, etc), objects (vehicle keys, current consumer goods) available (in particular for purchase or for hire) in a distributor, or systems for controlling access to a geographical zone (for example a secure zone located outdoors) for which access is limited to the bearers of an RFID chip card or an NFC label.

### BACKGROUND OF THE DISCLOSURE

The sharing systems, or self-service access, for vehicles are currently enjoying much success.

The operating principle of these systems is based on the use of a near field communication reader, of the RFID or NFC type, placed on or inside the vehicle, and compatible chip cards carried by the authorized users. These chip cards contain for example information relating to the subscription of the user, his rights, his contact information, etc. When a user wants to use such a vehicle, it brings his chip card close to the reader, thus triggering the access authorisation and the unlocking of the vehicle if all of the conditions are satisfied (current subscription, vehicle available, etc).

A disadvantage of this technique of prior art resides in the energy consumption of the near field communication reader, which must be active constantly in order to be able to read, at any time, a user card wanting to access a vehicle. The RFID readers that are currently available on the market consume for example between 10 mA and 250 mA when they are waiting for reading a card.

This high consumption is particularly prejudicial for battery-powered applications, for example for hiring vehicles, electric or not (such as a car or bicycle), parked while on standby for hiring.

Indeed, this consumption of the RFID reader contributes greatly in discharging the battery of the vehicle, which is harmful to the quality of the service rendered as the batteries of the vehicles can be discharged at the time they are hired, if the vehicle has remained for several days on standby for hiring. This also increases costs of management of the fleet of available vehicles substantially, as a more frequent verification of the charge condition of the batteries is required, as well as a more-frequent recharging of the batteries.

Certain solutions have been proposed in order to attempt to overcome these disadvantages, for example by waking up the RFID reader periodically, in order to reduce its consumption.

However, a disadvantage with such solutions resides in the fact that the reader is not active when a user wants to access a vehicle, as such requiring him to reiterate his request, by presenting his chip card again in front of the reader at a moment when the latter is awake. As such, the ergonomics of the system are degraded.

### SUMMARY

An embodiment of the present disclosure relates to a near field communication method, implementing at least one communication reader configured to exchange data with at least one nomadic object.

Such an exemplary method comprises:
a step of detecting a presence in the vicinity of the communication reader, delivering an activation information, when a presence is detected;
a step of activating the power supply of the communication reader, upon reception of the activation information;
a step of authorizing a self-service access according to at least one of said data exchanged.

As such, an exemplary embodiment based on a new and inventive approach in near field communication, making it possible to save the energy required for the operation of the communication reader, by powering it only when it has to be active to exchange data, instead of powering it constantly as in the existing techniques of prior art.

To do this, an embodiment enables to activate the power supply of the communication reader only when a presence is detected in the vicinity of the communication reader, rendering the latter active and able to operate as planned.

According to a particular embodiment, the step of detecting detects the presence of one of the nomadic objects.

As such, when a nomadic object, for example a chip card, is presented to the communication reader, in order to exchange data, the presence of this object is detected and the power supply of the communication reader is activated. The communication reader is then able to operate and read the data in the nomadic object, in order to carry out the planned processing.

According to a particular aspect of the disclosure, the detection of a presence is implemented by a proximity sensor.

Indeed, such a proximity sensor operates on short pulses of a few microseconds, one to ten times per second and as such has the advantage of consuming only a few tens of microamperes which is therefore up to one thousand times less than a communication reader that is constantly powered.

For example, such a proximity sensor is an optical proximity sensor.

As such, such a sensor can operate optimally even through a car windscreen or the window of a distributor, and even in the presence of water on the window, or in the presence of inclement weather, which is not the case for a proximity sensor of the capacitive type.

According to a particular characteristic of the disclosure, the proximity sensor is integrated into the communication reader, in such a way as to offer a compact system.

In this way, any presence in the vicinity of the communication reader is detected by the integrated proximity sensor, in particular the presence of a nomadic object intended to communicate data to the communication reader.

The proximity sensor can also be installed next to the communication reader.

In particular, such a communication reader is a reader of the type belong to the group comprising:
an RFID reader;
an NFC reader;
any other near field communication technique.

According to an exemplary embodiment, the method further comprises a step of deactivating the power supply of the communication reader according to a predetermined criterion.

As such, an aspect of the disclosure enables to deactivate the power supply of the communication reader, in such a way that it no longer consumes energy when it is waiting for reading data from a nomadic object for example.

This deactivation depends on one or several criteria, depending for example on the objectives sought in terms of performance of the system, and/or of the complexity of the implementation desired.

For example, the predetermined criterion belongs to the group comprising:
a predefined duration;
an inactive state of said communication reader.

As such, in a first case, the power supply of the reader is deactivated at the expiration of a predefined duration, after its activation. For example, it can be provided to turn off the power supply of the communication reader one minute after its activation, considering that the communication reader has the time, during this duration, to perform all of the required actions (reading the data in the nomadic object presented, taking into consideration this data that was read, for example, to validate the hiring of a vehicle and unlock the vehicle, or validating the purchase of an object proposed in a distributor and unlocking a door of the distributor, or verifying the access rights of the bearer of the nomadic object to a secure zone, and unlocking an access barrier to the secure zone, etc.).

In another case, the power supply of the reader is deactivated when the communication reader is once again in an inactive state. For example, an inactive state of the communication reader corresponds to a state wherein the reader is waiting for reading a near field communication signal from a nomadic object, in opposition to an active state wherein the communication reader is either in the process of exchanging data with a nomadic object, or in the process of processing the data that was read, etc.

In this case, it is detected that the communication reader is no longer active, before turning off the power supply to it.

According to an embodiment of the invention, said self-service access belongs to the group comprising:
an access to a vehicle;
an access to an object available in a distributor;
an access to a secure geographical zone.

Another aspect of the disclosure relates to a near field communication device, implementing at least one communication reader configured to exchange data with at least one nomadic object.

According to an example, such a device is able to implement the steps of the method described previously and comprises:
means for detecting a presence in the vicinity of the communication reader, delivering an activation information, when a presence is detected;
means of activating the power supply of the communication reader, upon receiving the activation information;
means of authorizing a self-service access according to at least one of said data exchanged.

This device can of course comprise the various characteristics relative to the near field communication method. As such, the characteristics and advantages of this device are the same as those of the method of near field communication. Consequently, they are not detailed any further.

Another aspect of the disclosure further relates to a computer program product that can be downloaded from a communications network and/or recorded on a non-transitory computer-readable medium, such as a support that can be read by a computer and/or that can be executed by a processor, comprising program code instructions for the implementation of the method described hereinabove.

### BRIEF DESCRIPTION OF THE DRAWINGS

Other characteristics and advantages shall appear more clearly when reading the following description of a particular embodiment, provided as a simple and non-restricting example, and the annexed drawings, wherein:

FIG. 1 shows an example of a system implementing a near field communication method according to an embodiment of the disclosure;

FIG. 2 shows the main steps of the near field communication method according to an embodiment of the disclosure;

FIG. 3 shows the structure of a near field communication device according to a particular embodiment of the disclosure.

### DETAILED DESCRIPTION OF ILLUSTRATIVE EMBODIMENTS

### 1. General Principle of an Exemplary Embodiment

The general principle of an exemplary embodiment of the disclosure is based on the occasional activation of the power supply of a near field communication reader, at the times when the reader has to be active, in such a way as to save the energy consumed by the reader, in particular when it is waiting for reading.

As such, according to an exemplary embodiment, the power supply of the communication reader is activated upon detection of a presence in the vicinity of the reader, i.e. only when the communication reader is potentially solicited to exchange data with a nomadic object, such as a chip card, for example.

In this way, when the communication reader is waiting for reading, or exchanging, data, its power supply is turned off and consequently it does not consume any energy, and when it has to be able to exchange data, i.e. when it has to be in active mode, its power supply is then activated.

An embodiment thus enables to turn off the power supply of the communication reader when it is once again standing by for reading, after a period of activity.

### 2. Description of an Embodiment

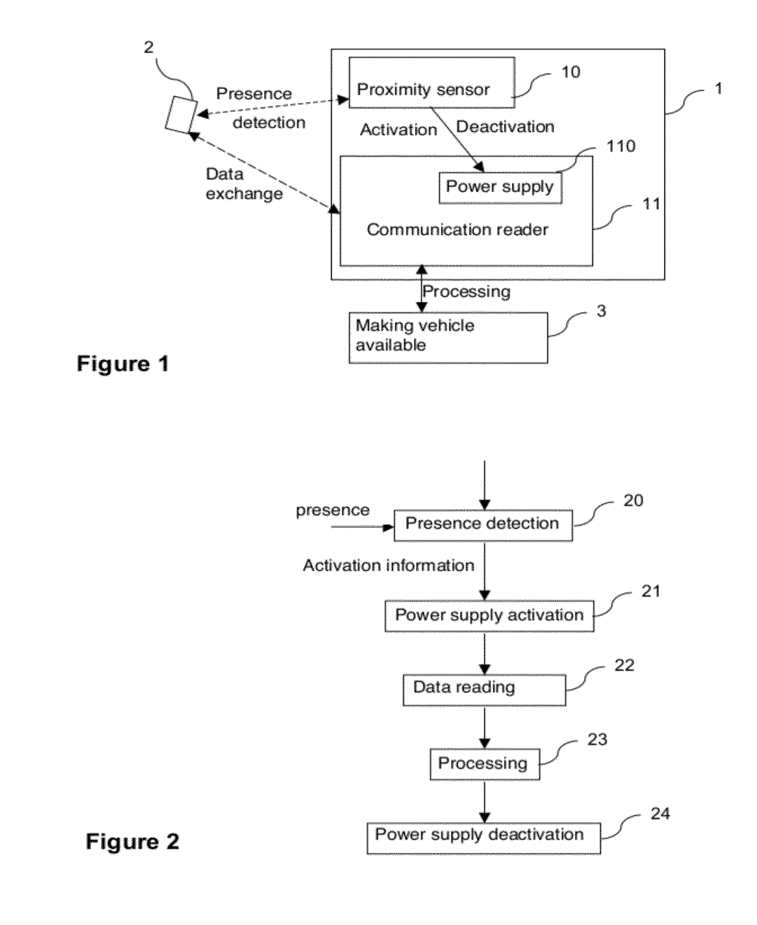

An example of a system implementing the near field communication method according to an illustrative embodiment is shown in relation with FIG. 1.

Consider for example a vehicle sharing service, allowing authorized users, for example subscribers to the service, to hire a vehicle parked on a parking lot, or in a garage, by the intermediary of a chip card containing data to be exchanged with a near field communication reader, of the RFID type for example, located on or in the vehicles to be hired.

Such a system comprises for example a communications device 1 according to this embodiment, comprising a proximity sensor 10 and a communication reader 11.

According to this embodiment, the power supply 110 of the communication reader is driven, or controlled, by the proximity sensor 10, i.e. turned off or turned on via an activation information (for example in the form of an interruption) or deactivation transmitted by the proximity sensor 10.

Proximity sensors of several types are known, capacitive or optical, for example.

In the embodiment shown in FIG. 1, the communication device comprises for example an optical sensor of the infrared type. Indeed, this type of sensor is advantageously selected for its performance of detecting presence, even when the conditions are not optimal (sensor behind a windscreen whereon water is trickling for example) and its low energy consumption.

For example, the infrared proximity sensor, or photoelectric sensor, comprises an emitter of light associated with a receiver. The detection of the presence of an object 2 in the vicinity is carried out by a cut-off or a variation in a beam of light.

Such an object 2, also called nomadic object, is for example a chip card containing data making it possible to a user to use the vehicle sharing service. This data is for example the contact information of the user, the references of his subscription, the state of his available credit, etc.

As such, as described hereinbelow in relation with FIG. 2, when the presence of the objet 2 is detected by the proximity sensor 10, the latter triggers an interruption (activation information or wake-up signal) which activates the power supply 110 of the communication reader 11, which enters into an active state and is able to exchange data with the object 2.

The communication reader 11 also processes this data and communicates for example with a module 3 for making a vehicle available, also called an external controller, which manages for example the locking and the unlocking of the vehicle, the authorisation to start the vehicle, etc.

The embodiment described hereinabove enables that the proximity sensor 10 and the communication reader 11 be integrated into a communication device 1, but it can also be considered, in other embodiments, that these two elements be independent and installed close to each other.

According to an embodiment of the invention, said communication reader is located in or on the vehicle.

As such, the invention allows the user to select the vehicle that he wants to use, simply and by approaching this vehicle.

In another embodiment of the invention, wherein the same device controls the access to several vehicles (for example a terminal, or distributor, located in a parking lot), the device can provide access to one of the available vehicles that it controls (by delivering for example a ticket indicating the location of the vehicle in the parking lot, accompanied with a key or an access code to the vehicle). This embodiment offers the advantage of requiring a more limited number of communication devices for the same fleet of vehicles and therefore to allow for economies of scale (a single terminal for the access to several vehicles, instead of a device for each vehicle).

In relation with FIG. 2, the main steps of the method implemented in a system such as shown in FIG. 1 and described hereinabove are now presented.

A first step 20 of detecting presence is implemented by the proximity sensor 10. This first step makes it possible in particular to detect the presence of a nomadic object presented by a user to the communication reader, in order to benefit from an associated service, for example the hiring of a self-service vehicle.

Upon detection of a presence during step 20, an activation information is sent, for example in the form of an interruption (wake-up signal), intended for the power supply 110 of the communication reader 11, in such a way as to activate it, during a step 21 of activating the power supply.

The activation of the power supply 110 of the communication reader 11 makes it possible to place the latter in an active state, i.e. able to exchange data with a nomadic object of which the presence has been detected.

For example, in the case of the service for hiring self-service vehicles, when a user presents his subscription card in the vicinity of the communication reader, the presence of the card is detected by the proximity sensor, which actives the power supply of the communication reader, which is then able to read the data, during a step 22 of reading data, in the chip card of the user.

Following this step 22, a step 23 of processing the data read is implemented, thus making it possible to satisfy the request of the user, if all of the conditions are verified.

For example, the step of processing 23 includes verifying the validity of the subscription, the available credit for the user, etc.

The step of processing 23 can also includes unlocking the vehicle if the user is authorized, in authorizing the starting, etc.

Finally, the step of processing 23 can also includes updating the data present on the chip card of the user, for example by decrementing the available credit in order to take the current hiring into account, etc.

A last step 24 of deactivating the power supply is implemented, in such a way as to turn off the power supply of the communication reader so that it does not consume any energy when it is waiting for reading.

This step 24 can be implemented according to one or several criteria.

For example, it can be implemented at the expiration of a predefined duration, selected according to the estimated time for the previous steps 22 and 23. As such, if it is considered that the reading and the processing of data by the communication reader lasts a few seconds, for example 5 seconds, then the deactivation of the power supply is implemented for example after 6 seconds after its last activation.

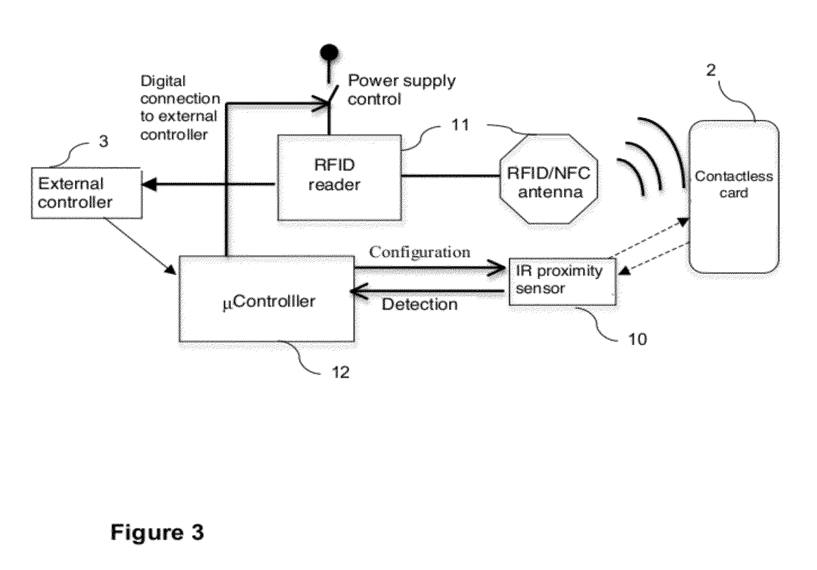

According to another example, information on the state of the communication reader is known by the external controller 3, making it possible to know when the communication reader is again inactive, i.e. neither in the process of reading data, nor in the process of processing this data that was read. In this case, when the external controller 3 knows that the communication reader is inactive, the external controller 3 sends a command making it possible to deactivate the power supply of the communication reader and to keep it turned off until the detection of a presence. This alternative is described in further detail in relation with FIG. 3.

As such, according to this embodiment, the consumption of the communication reader is reduced to the periods (of a magnitude of a few seconds) when it is effectively active, i.e. solicited to exchange data with a nomadic object and as such allow a user to benefit from the required service.

For example, if the processing time associated with the step of activating is estimated to be 1 ms, the duration of the step of reading the data to be 800 ms, and the processing for the data read to be 500 ms, an activation time for the device of about 1.3 s is reached each time a nomadic object is detected.

Outside of this period of exchange with the nomadic object (during which the consumption of the device is high due to the activation of the communication reader), only the infrared sensor is consuming energy and its consumption is very low.

In addition, the presentation of a nomadic object effectively occurs only from time to time in a day, in the case for example of the automatic hiring of vehicles (cars, bicycles, etc.) or, in another embodiment, of an access control.

Because of this, the average consumption of the communication device, comprising the proximity sensor, which consumes very little energy due to its operation via short pulses, and the communication reader consuming energy only occasionally when it is solicited, is therefore very low, and greatly reduced in relation to the techniques of prior art, while still providing the same service to users.

The quality of the service rendered is therefore optimal, while still providing low system maintenance costs as the energy consumption of the communication reader participates only very little in discharging the batteries of the system.

### 3. Alternative of the Invention

The principle of the invention, shown in detail in liaison with an authorisation of access to a vehicle, can also be used to control the access to a particular geographical zone, for example a secure zone located outdoors, or in a located that is not connected to an electrical network, for example an entrance to a construction site, a temporary event location such as a trade fair hall or a concert.

### 4. Structure of a Near Field Communication Device

In relation with FIG. 3, an example of a structure of a near field communication device, according to an illustrative embodiment of the disclosure, is presented.

Consider, as in FIG. 1, a communication reader 11 comprising an RFID reader, having conventionally a high consumption, and an associated antenna, a contactless card 2 and an infrared proximity sensor 10, of low consumption.

The performance of the infrared sensor is selected in such a way as to allow for the proper operation of the detection, for example in minimizing false detections and/or in maximizing the detection rate of target nomadic objects. This can for example be achieved with an infrared sensor using a wavelength of a magnitude of 850 nm, and generating pulses of 100 us, at 110 mA in amplitude, with a standby frequency between 2 pulses less than 800 ms.

The maximum consumption of the step of detecting must not exceed 140 uA.

According to the embodiment described in FIG. 3, when the proximity sensor 10 detects a presence, an information on the detection is transmitted by the proximity sensor 10 to a μcontroller 12, which then takes care of controlling the power supply of the communication reader 11. This μcontroller 12 is also able to configure the proximity sensor, according to predetermined criteria (sensitivity for detecting presence, adjustment of certain parameters, etc.).

Moreover, according to this embodiment, the communication reader is connected to an external controller 3, also called a module for making a vehicle available (FIG. 1), via a digital connection.

Moreover, according to an illustrative embodiment of the disclosure, the external controller 3 is also able to make the decision to deactivate the power supply of the communication reader 11, as it has knowledge of the entire transaction, i.e. of the return to the inactive state of the communication reader 11. In this case, the external controller 3 then raises a command on the μcontroller 12 which controls the power supply of the communication reader 11 in order to turn it off, or to place it in an “OFF” state.

Another aspect of the disclosure further relates to a computer program product that can be downloaded from a communications network and/or recorded on a non-transitory computer-readable medium, such as a support that can be read by a computer and/or that can be executed by a processor, comprising program code instructions for the implementation of the method described herein. For example the computer-readable medium can include a memory such as a random-access memory, an optical disc, a magnetic disc, a DVD, a read only memory, a volatile memory, a non-volatile memory, a data storage device, etc.

An exemplary embodiment of the disclosure provides a technique for near field communication making it possible to optimize the energy consumption of the communication reader, while offering optimal performance in terms of service to the user.

An exemplary embodiment provides such a technique that is simple as well as effective in terms of design, implementation and maintenance.

Although the present disclosure has been described with reference to one or more examples, workers skilled in the art will recognize that changes may be made in form and detail without departing from the scope of the disclosure and/or the appended claims.

What is claimed is:

1. A near field communication method, comprising:
implementing at least one communication reader configured to exchange data with at least one nomadic object;
detecting a presence in the vicinity of said communication reader, delivering activation information, when a presence is detected;
activating a power supply of said communication reader, upon reception of said activation information; and
authorizing a self-service access according to at least one of said data exchanged

2. The near field communication method according to claim 1, wherein detecting detects the presence of one of said nomadic objects.

3. The near field communication method according to claim 1, wherein detecting a presence is implemented by a proximity sensor.

4. The near field communication method according to claim 3, wherein said proximity sensor comprises an optical proximity sensor.

5. The near field communication method according to claim 3, wherein said proximity sensor is incorporated into said communication reader.

6. The near field communication method according to claim 1, wherein said communication reader comprises a reader of the type belonging to the group consisting of:
an RFID reader;
an NFC controller.

7. The near field communication method according to claim 1, wherein the method further comprises deactivating said power supply of said communication reader according to a predetermined criterion.

8. The near field communication method according to claim 7, wherein said predetermined criterion belongs to the group consisting of:
a predefined duration;
an inactive state of said communication reader.

9. The near field communication method according to claim 8, wherein said inactive state of said communication reader corresponds to a state wherein the reader is waiting for reading a near field communication signal from one of said nomadic objects.

10. The near field communication method, according to claim 1, wherein said self-service access belongs to the group consisting of:
an access to a vehicle;
an access to an object available in a distributor;
an access to a secure geographical zone.

11. A near field communication device, implementing at least one communication reader able to exchange data with at least one nomadic object, wherein the device comprises:
means for detecting a presence in the vicinity of the communication reader, delivering activation information, when a presence is detected;
means for activating a power supply of the communication reader, upon receiving the activation information; and
means for authorizing a self-service access according to at least one of said data exchanged.

12. A computer program product recorded on a non-transitory computer-readable medium, wherein the product comprises program code instructions for implementing a method of near field communication, the method comprising:
implementing at least one communication reader configured to exchange data with at least one nomadic object;
detecting a presence in the vicinity of said communication reader, delivering activation information, when a presence is detected;
activating a power supply of said communication reader, upon reception of said activation information; and
authorizing a self-service access according to at least one of said data exchanged
